(19) United States
(12) Patent Application Publication
(10) Pub. No.: US 2016/0160743 A1
(43) Pub. Date: Jun. 9, 2016

(54) WATER TO AIR INTERCOOLER HAVING PARALLEL COOLANT PATH

(71) Applicant: HYUNDAI MOTOR COMPANY, Seoul (KR)

(72) Inventor: JongMan JUN, Hwaseong-si (KR)

(21) Appl. No.: 14/799,489

(22) Filed: Jul. 14, 2015

(30) Foreign Application Priority Data
Dec. 3, 2014 (KR) 10-2014-0172128

(51) Int. Cl. F02B 29/04

(52) U.S. Cl. CPC F02B 29/0456

(57) ABSTRACT

A water to air intercooler includes a coolant path unit through which a coolant flows and having an inlet, an outlet, and a body. The coolant cools supercharged air supplied to an engine. An intercooler core discharges heat of the coolant flowing in the body of the coolant path unit. The body of the coolant path unit has two or more coolant paths formed in parallel.

### CROSS-REFERENCE TO RELATED APPLICATION

This application claims the benefit of Korean priority to Patent Application No. 10-2014-0172128 filed in the Korean Intellectual Property Office on Dec. 3, 2014, the entire content of which is incorporated herein by reference.

### TECHNICAL FIELD

The present disclosure relates to a water to air intercooler, and more particularly, to a water to air intercooler that can enhance cooling efficiency and reduce the size of thereof by forming coolant paths in parallel at a water to air intercooler core of the water to air intercooler.

### BACKGROUND

An internal combustion engine is powered by air and fuel such as gasoline. Such engine power for a vehicle is controlled according to an air/fuel ratio.

There are several methods applied to inject the fuel into the engine, and to draw the air into the engine.

Recently, the internal combustion engine has been developed in various ways to improve the engine power, fuel efficiency, and gas emissions and is available in a turbocharged engine, a turbo intercooled engine, etc.

The turbo intercooler engine has a turbo intercooler or an intercooler for increasing engine power by increasing air density through cooling compressed high-temperature air therein to increase an intake air amount that is supplied to an engine cylinder.

The turbo intercooler engine having the intercooler generates even higher engine power than a conventional naturally aspirated engine, and can reduce vibration, noise, and exhaust gas, and improve lifespan and fuel efficiency due to excellent power performance at a low speed.

The turbo intercooler engine includes an intercooler having the intercooler and having a similar structure as a radiator. The intercooler is classified into an air to air intercooler and a water to air intercooler. The air to air intercooler cools air supplied to the engine by the air flowing into an engine compartment when a vehicle runs, and the water to air intercooler cools the air supplied to the engine by a coolant.

The air to air intercooler has a simpler structure than that of the water to air intercooler, but has inferior cooling efficiency.

The water to air intercooler circulates the coolant of a radiator to cool supercharged-air (high-temperature compressed air).

A supercharged-air route may be shortened in the water to air intercooler compared with the air to air intercooler, thus the supercharged-air responsiveness therein may be improved as supercharged-air resistance decreases. In addition, according to the water to air intercooler, fuel efficiency and performance thereof may be improved by cooling the supercharged-air using the coolant with a large heat capacity.

As is well-known to a person skilled in the art, the faster the flow of the coolant is and the higher the temperature difference between the supercharged-air and the coolant is, the better the cooling efficiency of the water to air intercooler is.

FIG. 1 is a schematic drawing illustrating a single-core type of water to air intercooler, and FIG. 2 is a schematic drawing illustrating a multi-separated-core type of water to air intercooler. As shown in FIGS. 1 and 2, a water to air intercooler in general has a water to air intercooler core 20, 20a, or 20b in which a coolant path 10 is formed. The water to air intercooler further includes holes 30a and/or 30b through which supercharged air flows into and/or out of.

When a coolant path is formed in series at the water to air intercooler core 20, 20a, or 20b, the length of the coolant path and flowing resistance of the coolant increase, and thus, coolant temperature at an outlet of the coolant path becomes very high.

The above information disclosed in this Background section is only for enhancement of understanding of the background of the invention, and therefore, it may contain information that does not form the prior art that is already known in this country to a person of ordinary skill in the art.

### SUMMARY

The present disclosure has been made in an effort to provide a water to air intercooler capable of increasing cooling efficiency and reducing the size thereof by forming coolant paths in parallel at a water to air intercooler core of the water to air intercooler.

According to an exemplary embodiment of the present inventive concept, a water to air intercooler includes a coolant path unit, through which a coolant flows, having an inlet, an outlet, and a body. The coolant cools supercharged air supplied to an engine. An intercooler core discharges heat of the coolant flowing in the body of the coolant path unit. The body of the coolant path unit has two or more coolant paths formed in parallel.

The two or more coolant paths may diverge from the inlet of the coolant path unit, and converge at the outlet of the coolant path unit.

The intercooler core is a multi-separated core which has one or more coolant paths.

The inlet and outlet of the coolant path unit may be formed at the same side.

The inlet and outlet of the coolant path unit may be formed at opposite sides.

When the inlet and outlet of the coolant path unit are formed at the same side, the multi-separated core may have two or more coolant paths.

When the inlet and outlet of the coolant path unit are formed at the opposite sides, the multi-separated core may have one or more coolant paths.

As described above, according to the embodiment of the present inventive concept, a water to air intercooler may enhance cooling efficiency and reduce the size thereof by forming coolant paths in parallel at a water to air intercooler core of the water to air intercooler.

### BRIEF DESCRIPTION OF THE DRAWINGS

FIG. 1 is a schematic drawing illustrating a typical single-core type of a water to air intercooler.

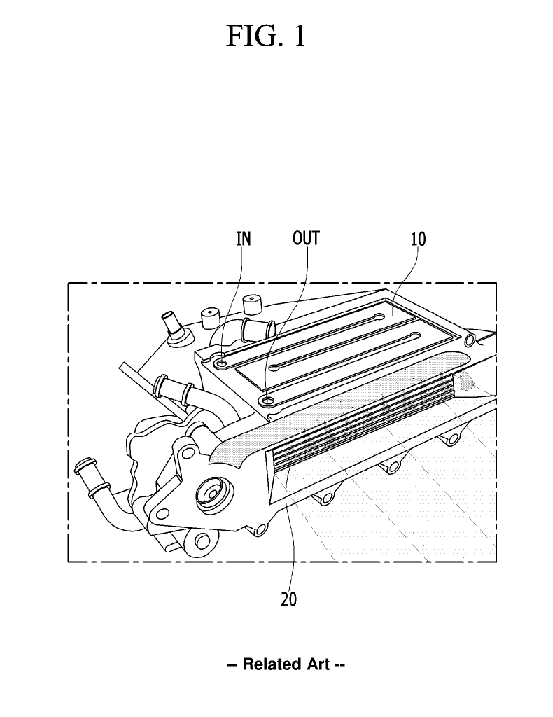

FIG. 2 is a schematic drawing illustrating a typical multi-separated-core type of a water to air intercooler.

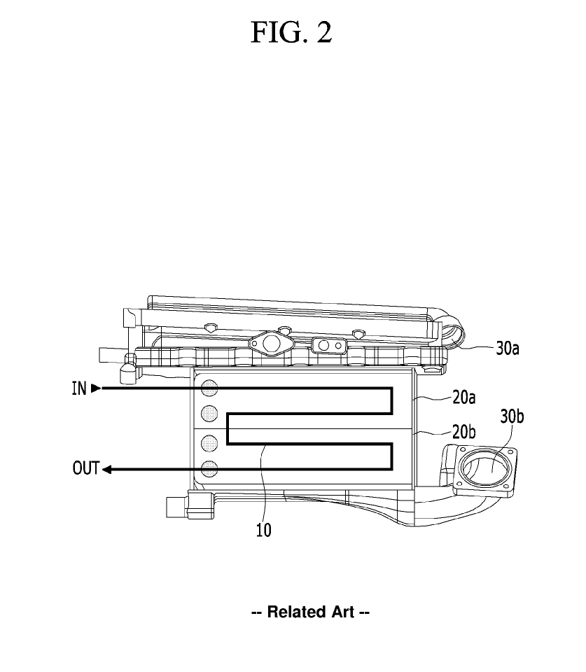

FIG. 3 is a schematic diagram of a water to air intercooler according to a first exemplary embodiment of the present inventive concept.

FIG. 4 is a drawing illustrating a coolant flow in a water to air intercooler according to a first exemplary embodiment of the present inventive concept.

FIG. 5 is a schematic diagram of a water to air intercooler according to a second exemplary embodiment of the present inventive concept.

FIG. 6 is a drawing illustrating a coolant flow in a water to air intercooler according to a second exemplary embodiment of the present inventive concept.

### DETAILED DESCRIPTION OF THE EMBODIMENTS

The present disclosure will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In addition, in the specification, unless explicitly described to the contrary, the word “comprise” and variations such as “comprises” or “comprising” will be understood to imply the inclusion of stated elements but not the exclusion of any other elements.

Like reference numerals designate like elements throughout the specification.

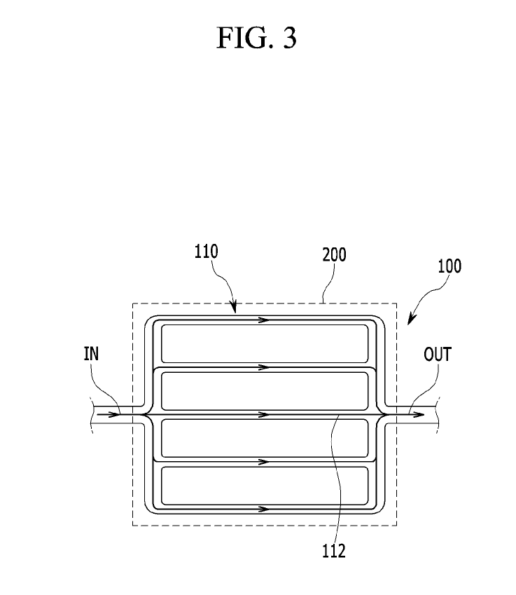

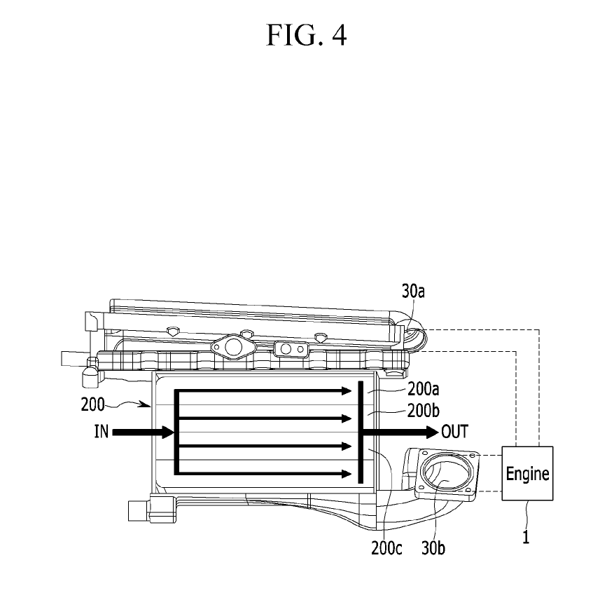

FIG. 3 is a schematic diagram of a water to air intercooler according to a first exemplary embodiment of the present inventive concept. FIG. 4 is a drawing for explaining coolant flow in a water-cooling intercooler apparatus according to the first exemplary embodiment of the present inventive concept.

Referring to FIGS. 3 and 4, a water to air intercooler according to a first exemplary embodiment of the present inventive concept includes a coolant path unit 100 having an inlet (IN), an outlet (OUT), and a body 110 so that a coolant flows therein. The coolant cools supercharged air supplied to an engine 1. A water to air intercooler core 200 (200a and 200b) discharges heat of the coolant flowing in the body 110 of the coolant path unit 100. The body 110 of the coolant path unit 100 may have two or more coolant paths 112 formed in parallel.

The two or more coolant paths 112 provided in the body 110 of the coolant path unit 100 may diverge from the inlet (IN) of the coolant path unit 100, and converge at the outlet (OUT) of the coolant path unit 100.

When the intercooler core 200 is a multi-separated core (200a, 200b, 200c, etc.) as shown in FIG. 4, each core included in the multi-separated core (200a, 200b, 200c, etc.) has one or more coolant paths.

The inlet (IN) and the outlet (OUT) of the coolant path unit 100 may be formed at opposite sides.

When the inlet (IN) and the outlet (OUT) of the coolant path unit 100 are formed at the opposite sides, each core of the multi-separated core (200a, 200b, 200c, etc.) may have one or more coolant paths.

In the first exemplary embodiment of the present inventive concept, materials and other configurations of the coolant path unit 100 and intercooler core may be those typically applied in the related art.

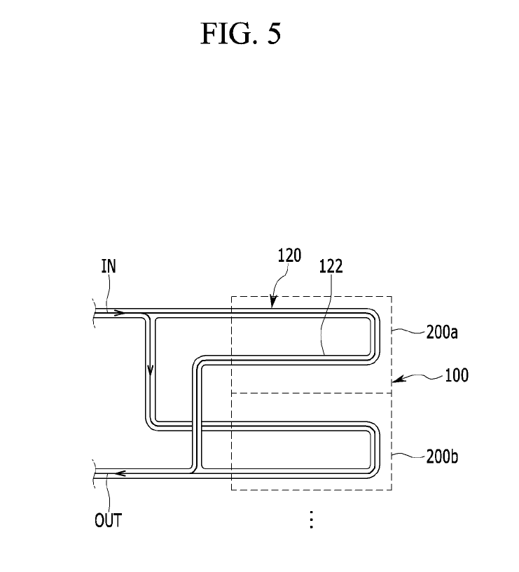

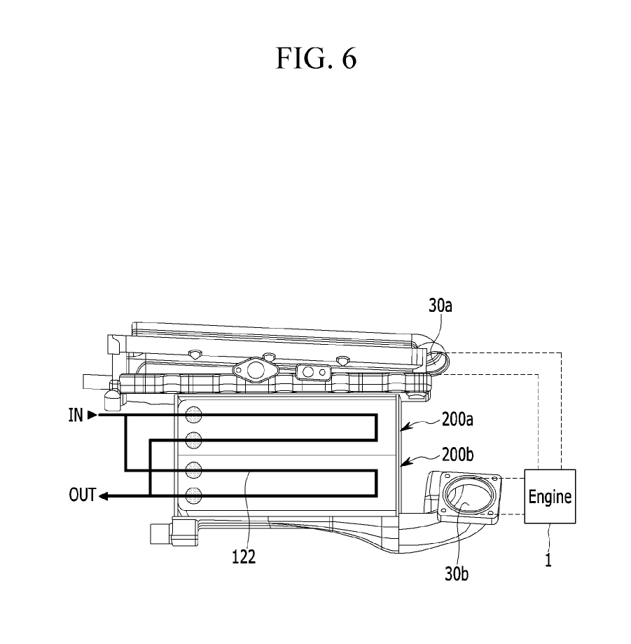

Referring to FIGS. 5 and 6, an inlet (IN) and an outlet (OUT) of a coolant path unit 100 according to a second exemplary embodiment of the present inventive concept may be formed at the same side.

Here, when the inlet (IN) and the outlet (OUT) of the coolant path unit 100 are formed at the same side, each core of multi-separated type of cores (200a, 200b) may have two or more coolant paths.

In the second exemplary embodiment of the present inventive concept, materials and other configurations of the coolant path unit 100 and intercooler core may be those typically applied in the related art.

In the exemplary embodiments of the present inventive concept, the inlet and outlet of the coolant path unit 100 are positioned at a left side or a right side of the coolant path unit 100, but it should be understood that the scope of the present disclosure is not limited thereto. Even if the configurations are different from the above configuration, the technical spirit of the present disclosure may be applicable to any configuration in which the coolant can substantially flow, for example, in which the inlet and the outlet are formed at an upper side or a lower side thereof.

Further, in the exemplary embodiments of the present inventive concept, the coolant paths are illustrated as formed in a horizontal direction, but it should be understood that the scope of the present disclosure is not limited thereto. Even if the configurations are different from the above configuration, the technical spirit of the present disclosure may be applicable to any configuration in which the coolant can substantially flow, for example, in which the coolant paths are formed in a vertical direction or a tilted direction.

A water to air intercooler will now be described in detail with reference to the accompanying drawings.

Referring to FIGS. 3 to 6, a coolant inside the inlet is diverged to respectively flow into a coolant path 112 or 122 formed at a body 110 or 120 of the coolant path unit 100 in parallel.

After the coolant flows in the coolant path 112 or 122 formed at the body 110 or 120 of the coolant path unit 100 in parallel, the coolant converges on the outlet (OUT) of the coolant path unit 100 and is discharged.

Since the coolant inside the inlet is diverged and respectively flows into the coolant path 112 or 122 formed in parallel, flowing resistance of the coolant decreases. Accordingly, a coolant flow rate increases, and cooling efficiency is improved.

Therefore, according to the present disclosure, it is possible to enhance cooling efficiency and reduce the size of thereof by forming coolant paths in parallel at a water to air intercooler core of the water to air intercooler.

While this invention has been described in connection with what is presently considered to be practical exemplary embodiments, it is to be understood that the invention is not limited to the disclosed embodiments, but on the contrary, is intended to cover various modifications and equivalent arrangements included within the spirit and scope of the appended claims.

What is claimed is:

1. A water to air intercooler comprising:
a coolant path unit, through which a coolant flows, having an inlet, an outlet, and a body; and
an intercooler core discharging heat of the coolant which flows into the body of the coolant path unit,
wherein the coolant cools supercharged air supplied to an engine, and
the body of the coolant path unit includes two or more coolant paths arranged in parallel.

2. The water to air intercooler of claim 1, wherein the two or more coolant paths diverge from the inlet of the coolant path unit, and converge at the outlet of the coolant path unit.

3. The water to air intercooler of claim 1, wherein when the intercooler core is a multi-separated core, each multi-separated core includes one or more coolant paths.

4. The water to air intercooler of claim 3, wherein the inlet and the outlet of the coolant path unit are formed at the same side.

5. The water to air intercooler of claim 3, wherein the inlet and the outlet of the coolant path unit are formed at opposite sides.

6. The water to air intercooler of claim 4, wherein when the inlet and the outlet of the coolant path unit are formed at the same side, each multi-separated core has two or more coolant paths.

7. The water to air intercooler of claim 5, wherein when the inlet and the outlet of the coolant path unit are formed at the opposite sides, each multi-separated core has one or more coolant paths.

8. The water to air intercooler of claim 1, further comprising holes through which the supercharged air flows into and out.
